(19) United States
(12) Patent Application Publication
(10) Pub. No.: US 2009/0120736 A1
(43) Pub. Date: May 14, 2009

(54) AUTOMATIC BRAKING FOR A MANUALLY CONTROLLED WHEELED CART

(76) Inventors: Daniel J. Masterson, Geneva, IL (US); Dennis Gruber, Arlington Heights, IL (US); Daniel Namie, Elburn, IL (US); Dipan Surati, DesPlaines, IL (US)

Correspondence Address: MICHAEL BERNS;MALONEY, PARKINSON AND BERNS, 135 W MAIN STREET, URBANA, IL, 61801, US

(21) Appl. No.: 11/758,583

(22) Filed: Jun. 5, 2007

Related U.S. Application Data
(60) Provisional application No. 60/810,829, filed on Jun. 5, 2006.

(51) Int. Cl. B62B 9/08

(52) U.S. Cl. 188/19

(57) ABSTRACT

The present invention is a manually controlled and propelled wheeled vehicle whose wheels are locked or held in place via a braking mechanism. This invention includes a proximity sensing mechanism that determines when an operator is sufficiently in control of the wheeled vehicle. Upon an operator presence being determined, the proximity sensor calls for the release of the wheel locks and or braking mechanisms. Once the operator is no longer in the proper position, the wheel locks or brakes re-engage.

### CROSS-REFERENCE TO RELATED APPLICATIONS

This application claims the priority of Provisional Application 60/810,827 filed on Jun. 5, 2006, which is hereby incorporated by reference in its entirety.

### BACKGROUND OF THE INVENTION

1. Field of the Invention

The present invention relates to manually propelled and controlled wheeled carts. Particularly, the present invention relates to typical versions of a manual cart including child strollers, shopping carts, mail carts, food carts, hand trucks, wagons, golf club pull carts, and the like.

Consumer research has pointed to the troublesome and generally acknowledged and frequently experienced cart drift associated with shopping carts u especially in high wind environments.

Manually controlled carts are present in a wide variety of applications and used to facilitate the transport of infants, groceries, mail, food, appliances, recreational equipment, and a multitude of other items. For all free wheeling manual carts, the risk of drift or a “runaway” event is present whenever the operator lets go of the handle and the cart is allowed to stand freely. Generally gravity (on an incline) or a wind gust (anywhere) initiates the undesired and uncontrolled movement.

2. Description of Related Art

Current solutions to this issue are strictly mechanical in nature. One such general alternative required the operator to engage a brake or wheel lock whenever it is desired to keep the cart still. Another alternative requires that a brake be disengaged by manual compression of a bar or handle while operating the vehicle. The former solution requires specific action on the part of user and employs often difficult to find or operate locks at the wheel. This solution can be cumbersome to operate, time consuming to find, and confusing in activation, leaving the operator wondering how and if the brake or lock is engaged properly. The latter solution fatigues the operator's hands during extended and even brief operation.

Published US Patent Application number 2007/0051366 A1 (Marlow) describes further prior art such as manually grasped brake releases that tend to cause user fatigue and are generally rejected as less than ideal solutions to the described runaway cart problem. Furthermore, the attempt by Marlow to solve this recurring and widely experienced issue lacks all executional details. There are no specifics describing even the basics of any of the key components required to make such an idea operational. The prior description lacks all details regarding the challenges of “tactile sensing” reliability and circuitry. In general, there is no specification regarding the sensing technology or mechanism used in the disclosure. Furthermore, there is no discussion of power management that is crucial to sensing apparatuses and the mechanisms the sensors might drive to lock or unlock a wheel.

In general, the present invention endeavors to provide a safety improvement to known manually controlled wheeled carts.

### SUMMARY OF THE INVENTION

The present invention is a manually controlled and propelled wheeled vehicle whose wheels are locked or held in place via a braking mechanism. This invention includes a proximity sensing mechanism that determines when an operator is sufficiently in control of the wheeled vehicle. Upon an operator presence being determined, the proximity sensor calls for the release of the wheel locks and or braking mechanisms. Once the operator is no longer in the proper position, the wheel locks or brakes re-engage.

### DESCRIPTION OF THE DRAWINGS

In order that the invention may be more readily understood and put into practical effect, reference will now be made to the accompanying drawings which will illustrate a preferred embodiment of the invention and wherein;

FIG. 1 is a system schematic of an automatic braking system using an e-field sensor, DC power supply, and solenoid driven locking or braking mechanism.

FIG. 2 is an electronic schematic of a light beam sensor to drive and actuate a braking mechanism.

FIG. 3 is a schematic using an RF proximity sensor transponder with micro-controller to drive and actuate a braking mechanism.

FIG. 4 is a solenoid driven wheel lock interface.

FIG. 5 is a manual over-ride mechanism to un-set the automatic braking or locking mechanism.

### DETAILED DESCRIPTION OF THE INVENTION

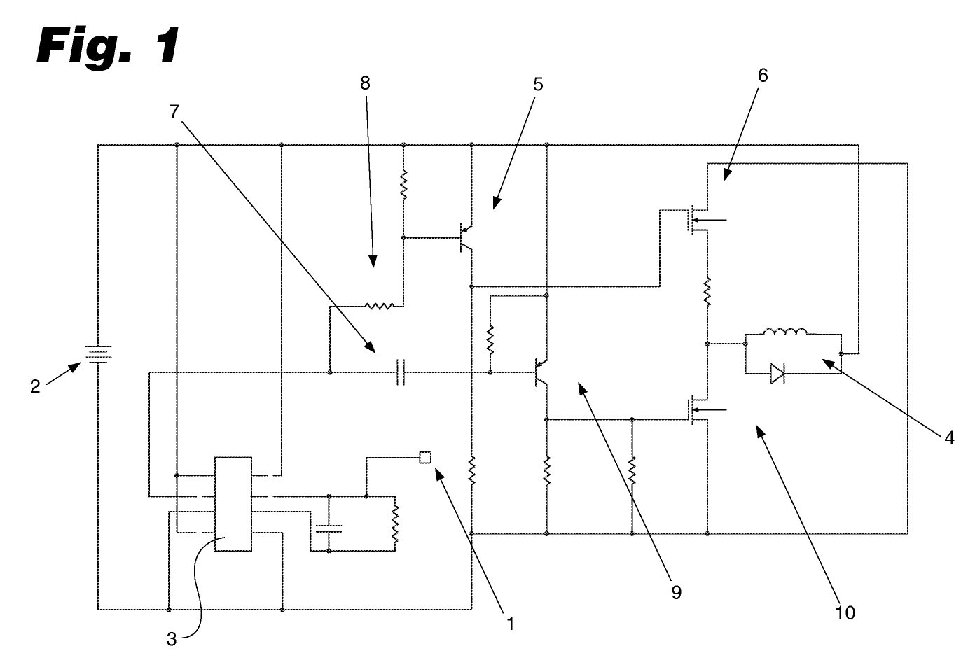

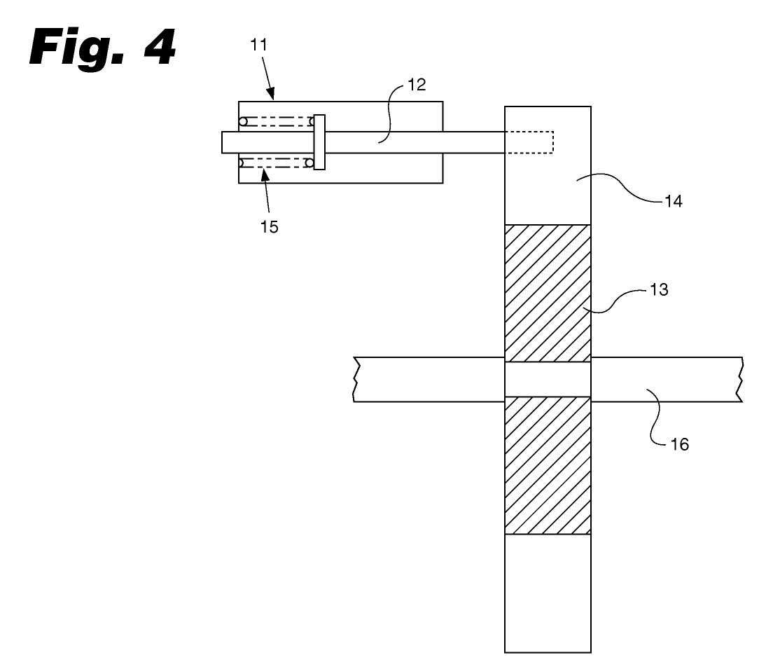

As shown in FIG. 1, the entire sensing and actuating circuit in the absence of a sensed presence by the electrode, 1, is at rest and draws no power from the power supply, 2. The electrode can be any number of items that can comprise or function as an antenna. In this case, the invention uses an ultra thin wire, specifically a 0.005 gauge, ¼ pound, soft stainless steel wire, wrapped around the handle of a child stroller. The electrode acts as an e-field sensing transmitter such that, when a capacitive connection to ground (typically a human hand) is seen, the electrode sends a signal to the e-field sensor chip, 3, in this case a Quantum QT113 chip. The sensitivity of the electrode that determines how close an operator must be to sufficiently disrupt the electric field is controlled by the capacitor, 4. In this specification, the capacitor can be within the range of 1 to 100 micro-farads but preferably 10 micro-farads. By doing so, the sensitivity is set to see a human hand within 0.005 inches. Similar types of electric field or capacitive sensors, like the Freescale Mc33794, Freescale 33941, Freescale 33940, or Cypress Cy8c21 can be used in lieu of the Quantum chip and may even be preferred in some applications. Once the sensing system sees an e-field disruption, it calls for the activation of a solenoid, 4. Because a solenoid draws more power than the power supply, 2, can sufficiently supply for a long enough period of time, the circuit shown in FIG. 1 depicts a two stage activation. The first stage provides full power to draw the hammer of the solenoid into the chassis using transistor, 5, and mosfet, 6. This full power activation is temporary û operating at full power from 0.1 to 0.5 seconds. In this embodiment, the capacitor, 7, in series with the resistor, 8, operates the circuit at full power for about 0.25 seconds. Similarly, a second, lower driving energy is required to hold the solenoid hammer in place once the first action has moved it into place. In this case, a second transistor, 9, and mosfet, 10, hold the solenoid hammer in place until the electrode, 1, no longer sees an e-field disturbance at which point the circuit stops supplying power to the solenoid, 4, causing the hammer to extend out of the chassis and engage the wheel lock. Alternatives to the actuator driver sequences displayed here can be any relay, solid state relay, or solid state switching device. The solenoid itself that moves the wheel lock physically into an out of a locked position can be supplanted by a DC motor, piezo electric device, hydraulic, or pneumatic system. Each of these drivers can be used in a similar fashion to the solenoid shown in FIG. 4. In FIG. 4, the interaction of the solenoid is shown in some detail. Once an e-field disruption is seen by the sensing circuit shown in FIG. 1 (or by other circuits generally described), the power supplied to the solenoid, 11, energized its magnetic coils and centers the solenoid hammer, 12, causing the hammer, 12, to retracts from the path of a disk, 13, with intermittent extensions, 14, with sufficient enough free space to accept the introduction of the solenoid hammer, 12, between consecutive radial extensions, 14. The solenoid hammer, 12, is biased to the protracted position by use of a compression spring, 15, that maintains enough force to extend the hammer, 12, into the path of the extensions, 14, when the solenoid, 11, receives no power from the sensing circuit. The disk, 13, and the extensions, 14, are coupled intimately to the wheel axle, 16, such that when the rotation of the extension, 14, is interrupted so too is that of the disk, 13, and axle, 15, and therefore the vehicle wheels. Alternatively, the spring biased solenoid hammer could have at its terminal end a rubber stopper or other frictional braking material that, rather than mechanically interrupting radial extensions, compresses upon a radial surface to apply a frictional force and resistance to free rotation that would cause the vehicle to slow and then hold its position.

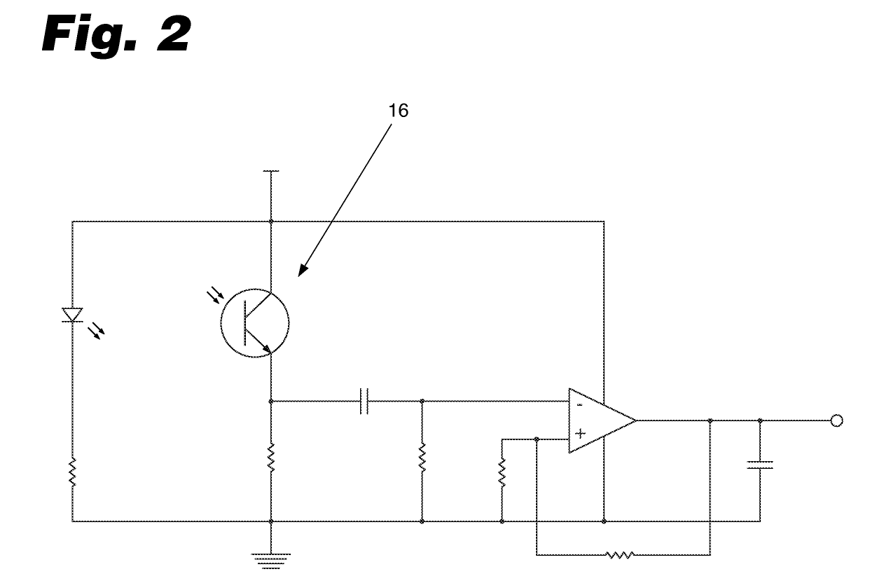

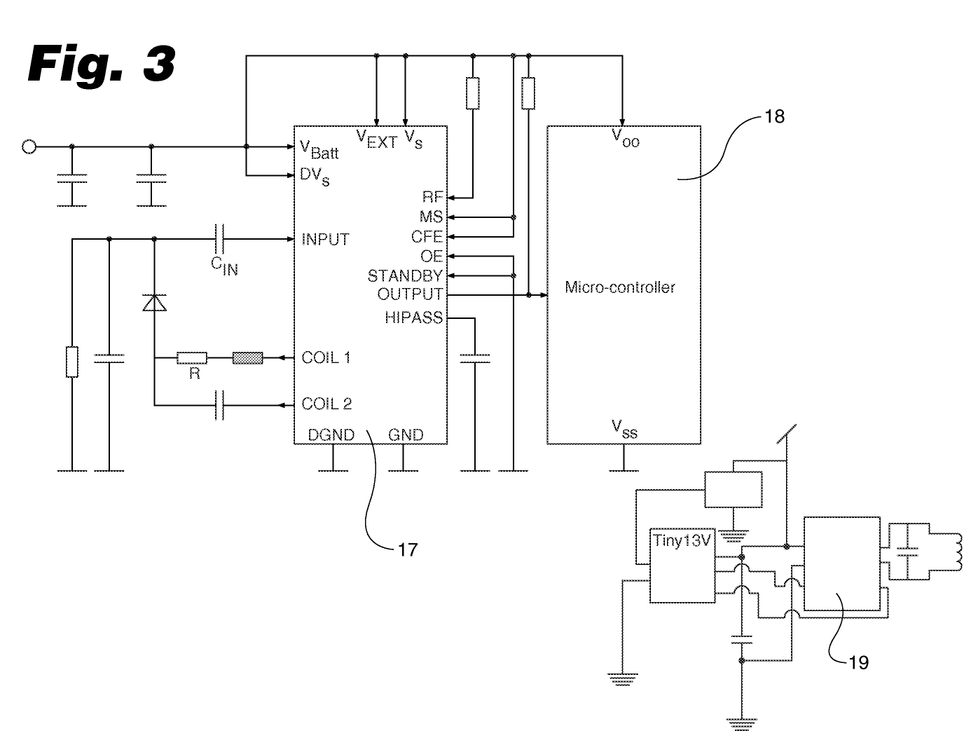

Alternatives to the e-field sensing actuation with an example in FIG. 1 include light interruption and radio frequency interfacing. Each of these alternatives is shown in FIG. 2 and FIG. 3 respectively. In the example shown in FIG. 2, an IR sensor light curtain, 16, is used in a similar fashion to the e-field sensing circuit. In this embodiment, the sensing circuit would drive the actuator mechanism and solenoid of FIG. 1 but is capable of operating any of the alternatives describes in this specification. FIG. 3 depicts the two portions of any typical radio frequency proximity sensing system. The first part uses the RF transponder, 17, and the microcontroller, 18, to seek the second part of the system, the RFID tag, 19. The circuit drawn in FIG. 3 is shown to activate the brake or lock release upon proximity of the two portions of the circuit. In addition, a circuit using RF signaling can be designed to activate the brake release upon proximity and sound an audible and/or visual alarm when the distance between the transponder and RFID tag is too great.

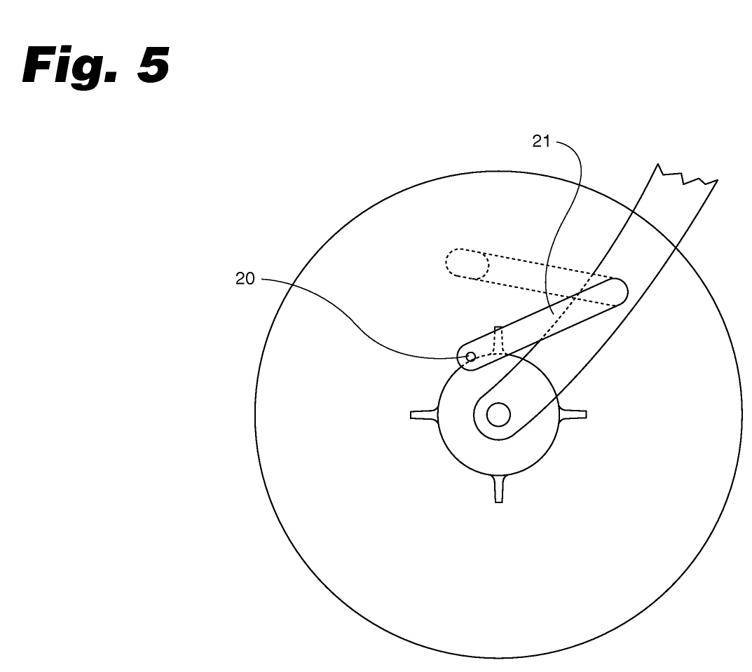

Since all the circuits are designed to fail safely; meaning that the wheels are locked or brakes applied in the absence of any power, it might be necessary to over ride such a circuit manually such that the operator can wheel the cart with the safety brake disengaged should the operator and circumstances dictate it. In this case, a manual over ride, like the one shown in FIG. 5, can be used to manually displace the wheel locking or braking mechanism upon deactivation by the operator. FIG. 5 shows how a locking mechanism of FIG. 4 might be removed from operation. In this description, the solenoid, 20, is rotated out of position by a lever arm, 21, affixed to a non-moving portion of the wheeled vehicle. This rotating lever, 21, can be held in either of its two positions (engaged or disengaged) by using a two position hinge.

While the above is merely an illustrative embodiment of the invention, all such variations and modifications thereto would be apparent to persons skilled in the art and are deemed to fall within the broad scope and ambit of the invention as herein defined in the appended claims.

We claim:

1. A manually propelled and directed wheeled vehicle comprising at least one wheel and at least one braking mechanism biased to a locked position using at least one proximity sensing circuit to actuate at least one brake mechanism using at least one portable power supply.

2. The wheeled vehicle according to claim 1, wherein the locking mechanism is a movable rod that mechanically interrupts the wheel rotation by mechanically prohibiting uninhibited rotation and effectively locking the wheel.

3. The wheeled vehicle according to claim 2, further comprising a solenoid locking mechanism to magnetically remove a biased pin from the path of a turning wheel.

4. The wheeled vehicle according to claim 2, further comprising a direct current motor to unlock the at least one wheel by turning a mechanically biased locking pin away from the at least one wheel.

5. The wheeled vehicle according to claim 1, wherein the braking mechanism uses a frictional bumper means to apply a drag force to the wheel rotation to slow the vehicle first and then subsequently hold it in place with sufficient force to prevent movement.

6. The wheeled vehicle according to claim 1, further comprising an electric field sensing mechanism to sense when an operator is in or near a controlling position.

7. The wheeled vehicle according to claim 1, further comprising an infrared interrupt sensor to determine the proper location of a vehicle operator.

8. The wheeled vehicle according to claim 1, further comprising a radio frequency module to sense the presence of an operator who holds the radio frequency key.

9. The wheeled vehicle according to claim 8, wherein the radio frequency module includes means for providing an alarm when the operator is too far from the vehicle.

10. The wheeled vehicle according to claim 1, further comprising powered by a primary battery cell.

11. The wheeled vehicle according to claim 1, further comprising a secondary battery cell.

12. The wheeled vehicle according to claim 11, wherein the secondary battery cell is rechargeable by a solar recharger.

13. The wheeled vehicle according to claim 11, wherein the secondary battery cell is mechanically recharged by the rotation of the wheels.

14. The wheeled vehicle according to claim 1, wherein the wheel braking assemble can be manually removed out of the path of the moving wheel to temporarily disengage the braking mechanism upon discretion of the operator.
